(19) United States
(12) Patent Application Publication
(10) Pub. No.: US 2011/0179891 A1
(43) Pub. Date: Jul. 28, 2011

(54) AUTOMATIC TRANSMISSION HAVING HYDRODYNAMIC CONVERTER

(76) Inventor: Busch Jorg, Kaiserslautem (DE)

(21) Appl. No.: 12/737,658

(22) PCT Filed: Aug. 1, 2008
(86) PCT No.: PCT/EP2008/006370

§ 371 Date: Apr. 8, 2011

Related U.S. Application Data
(60) Provisional application No. 60/973,913, filed on Sep. 20, 2007.

(30) Foreign Application Priority Data
Sep. 20, 2007 (EP) 07018532.7

(51) Int. Cl. F16H 47/06; F16H 37/00; F16H 47/08

(52) U.S. Cl. 74/15.8; 74/730.1; 475/59

(57) ABSTRACT

An automatic transmission (1) presents a hydrodynamic converter (3). Consequently, the automatic transmission (1) has a drive region (2) and a driven region (4). The power is split into at least two power branches in the drive region (2). A power branch runs across the hydrodynamic converter (3), another runs parallel thereto. Said at least two power branches are united in the driven region (4). According to the invention, one electrical machine (5) is additionally coupled with the driven region (4).

The invention concerns an automatic transmission fitted with a hydrodynamic converter, which includes a drive region, wherein the power can be split in at least two power branches, wherein a power branch runs across the hydrodynamic converter, and which includes a driven region, wherein said at least two power branches can be united.

Automatic transmissions fitted with a hydrodynamic converter are disclosed in the state of the art. They generally present a branched power flow, for which a portion of the power under set operating modes runs across the hydrodynamic converter, while another portion of the power runs parallel thereto via a mechanically coupled power branch, which typically exhibits transmission elements.

Document DE 101 52 488 A1 moreover discloses a drive unit for vehicle, wherein a converter transmission unit is combined with an electrical machine. The electrical machine is driven by electricity from a generator and is indirectly coupled with the wheels of the vehicle, wherein the coupling includes a transmission fitted with said hydrodynamic converter. The structure is hence a conventional serial hybrid drive in principle, whereas electric energy is provided via a combustion engine and a generator, which is then used for driving via an electric motor. Since in conventional hybrid drives the electrical drive machine is used as a generator when braking the vehicle down, hybrid drive systems thus offer the opportunity to recover energy when braking.

The described structure however shows the shortcoming that due to the coupling across the hydrodynamic converter braking is impossible via the generator-powered drive motor until standstill, so that energy gets lost which in principle could be recovered.

The object of the present invention is to hybridate an automatic transmission fitted with a hydrodynamic converter and to optimise said hybridation.

The object of the invention is met in that additionally an electrical machine is coupled with the driven region.

The driven region of the automatic transmission usually enables the junction of the previously branched powers, so as to make said powers available to the power take-off. Usually, a drive train can be transmitted directly mechanically and a drive train can be transmitted via the hydrodynamic converter. Both these drive trains are united in the driven region. The automatic transmission can even be driven using any power sources. Typically however, a combustion engine will be used here most of the time.

According to the invention, one electrical machine is additionally coupled with the driven region. The coupling of the electrical machine with the driven region hence enables to inject energy directly into the power take-off, or in the case of excessive energy in the power take-off (when braking) to recycle the former into useful electrical energy when the electrical machine is powered by a generator. The integration of the electrical machine into the driven region enables to provide said energy instead of the or together with the hydrodynamic converter, alternately or parallel to the mechanical power branch on the power take-off of the automatic transmission. An operating mode would consist for example in assisting the converter with the electrical machine when starting in the first gear, further along the operation, that is to say in the second gear and higher, the propulsion only takes place via a mechanical'power branch, wherein the electrical machine can intervene as a back-up during acceleration cycles and supply power. When braking down from higher rotation speeds and rather high breaking powers, the converter can also achieve a braking effect. The electrical machine can hence intervene as a back-up. During additional respectively normal braking down until standstill, which with the converter on its own would not be possible, the electrical machine can then be used particularly advantageously.

In a first advantageous embodiment of the invention, the electrical machine is hence coupled directly with said mechanical power branch without the hydrodynamic converter. This enables a simple and compact structure, wherein the electrical machine can be used efficiently when driving as well as when braking thanks to the direct integration.

In an alternative embodiment, the electrical machine is coupled directly with said at least one power branch, which runs across the hydrodynamic converter.

This coupling of the electrical machine, for instance with the turbine shaft of the hydrodynamic converter, allows additional operation of the electrical machine parallel to the converter, which can then take place in particular even in purely mechanical operating modes, when the converter is emptied. The electrical machine can hence take over the drive functionality as well as the brake functionality of the converter immediately or, if the converter is full up or partially filled, operate as a complement thereto. Advantageously the converter only needs to be configured relative to the combustion engine. The electrical machine does not influence the converter.

According to a particularly favourable embodiment of the present invention, the coupling of the electrical machine then involves a transmission element.

The transmission element which for instance can be designed as a planetary gear, enables to couple the electrical machine with a selectable or fixed transmission ratio into the driven region, so that the selection of the electrical machine can be performed more flexibly. So a smaller spread of the rotation speed is possible with the electrical machine, when said machine can be coupled via a transmission element with an appropriate transmission ratio, or with selectable transmission ratios, with appropriate transmission ratios, into the driven region. Moreover, this constellation enables to realise higher power take-off rotation speeds.

In a particularly favourable further embodiment of the invention it is moreover provided that the electrical machine can be decoupled from the driven region using a coupling element.

This decoupling of the electrical machine which for instance may involve a lamella coupling, enables to decouple the electrical machine completely to provide a structure which can be compared with a previous transmission fitted with a hydrodynamic converter. There is thus the advantageous possibility to select between a hybridated operation and a traditional operation.

Another particularly favourable embodiment of the invention alternately foresees to arrange a free-wheel between the turbine of the hydrodynamic converter and the electrical machine.

Such a free-wheel has hence the advantage of transmitting a corresponding force in one direction only while avoiding any drag losses of the turbine in the gears, wherein the power must be transmitted via the drive train without the hydrodynamic converter. Emptying the converter can thus be dispensed with since also no losses may occur when the converter is filled.

In a particularly favourable variation of the invention, where the electrical machine is coupled to said at least one power branch with the hydrodynamic converter, the connection between the electrical machine and the hydrodynamic converter is moreover provided with a coupling element.

This particularly advantageous structure enables, to separate the hydrodynamic converter and the electrical machine. Consequently, the power branch can be operated purely electrically with the hydrodynamic converter in this configuration of the invention. This offers for instance the advantage that the electrical operation can be provided by a generator as well as by a motor, without forcing the hydrodynamic converter to move along. The hydrodynamic converter can hence be kept filled with the working fluid in certain operating modes wherein it is not operated. The hydrodynamic converter thus remains ready to brake in these operating modes so' that when braking with the hydrodynamic converter, typical at high revolution speeds, it is possible to react very quickly alternately or in complement to the generator-powered operation of the electrical machine. Since the converter need not be filled first of all, closing the lamella coupling is sufficient to activate the hydrodynamic converter then ready to brake. The advantageous result is a very quick reaction of the converter when braking.

In a particularly favourable embodiment of the automatic transmission it is moreover provided that the power take-off is designed in such a way at least two selectable transmission ratios are available between the power take-off of the hydrodynamic converter which can be coupled with the electrical machine and the power take-off of the automatic transmission.

This structure enables optimal design of the converter as well as of the electrical machine as regards its rotation speed properties, without any excessive spread, since the corresponding spread can be obtained via the selectable transmission ratios. Moreover, higher rotation speeds can thus be provided.

According to a very advantageous variation of the invention it is moreover provided that the electrical machine can be coupled to the power take-off directly via a coupling.

The direct coupling of the power take-off of the automatic transmission to the electrical machine enables to achieve a 1:1 transmission ratio in the power take-off. Consequently the electrical machine should not present any high maximum rotation speed and can hence be configured particularly in a cost and energy efficient manner, heavy-duty and with small space requirements.

In a very favourable and advantageous configuration of the automatic transmission according to the invention it is hence provided that the driven region exclusively includes a planetary gear with fixed coupling structure.

This structure wherein a single planetary gear with fixed coupling structure is arranged in the driven region of the automatic transmission enables to produce the automatic transmission quite simply, with a few elements and hence in particularly cost efficient manner. The structure can moreover be extremely compact with little construction space requirements which for instance could be used by the electrical machine. The shortcoming of this structure is now that no reverse gear can be obtained via the mechanical respectively mechanical/hydrodynamic drive train, since the coupling structure cannot be modified in the driven region. Thanks to the electrical machine, a reverse gear can still be achieved quite simply and efficiently via said electrical machines that the missing possibility for modifying the coupling structure has no noteworthy influence on the functionality of the automatic transmission according to the invention. Without detriment to functionality, the structure can still be achieved in an accordingly simple and compact manner.

According to an advantageous further embodiment of the invention, the electrical machine is consequently incorporated to the housing of the automatic transmission.

The result is a very compact structure of the automatic transmission. This structure can moreover enable to design the automatic transmission respectively its housing as regards its external sizes in such a way, that a hybridated version can be replaced with a traditional version with similar construction space requirements. Consequently, a modular structure is possible on the vehicle side wherein hybridation can be complemented or retrofitted with minimum effort and without modifying the chassis.

Further advantageous aspects of the invention appear in the exemplary embodiments illustrated with the accompanied drawings.

Wherein:

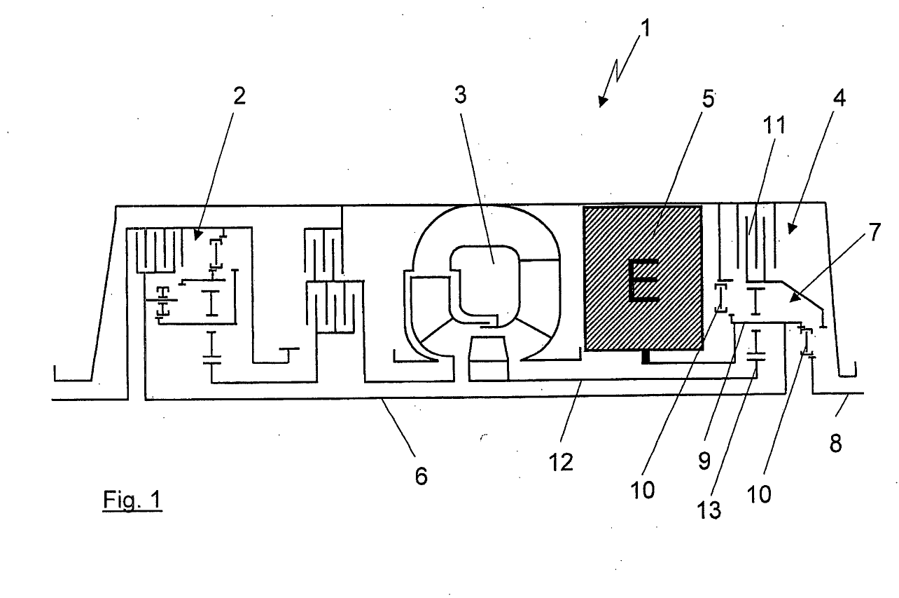

FIG. 1 shows a first embodiment of the automatic transmission according to the invention;

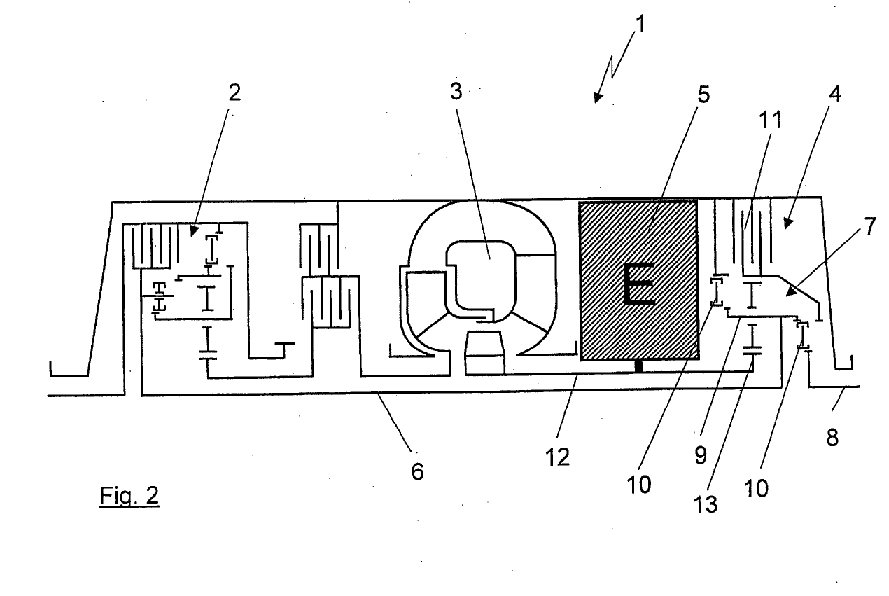

FIG. 2 shows another embodiment of the automatic transmission according to the invention in a first configuration;

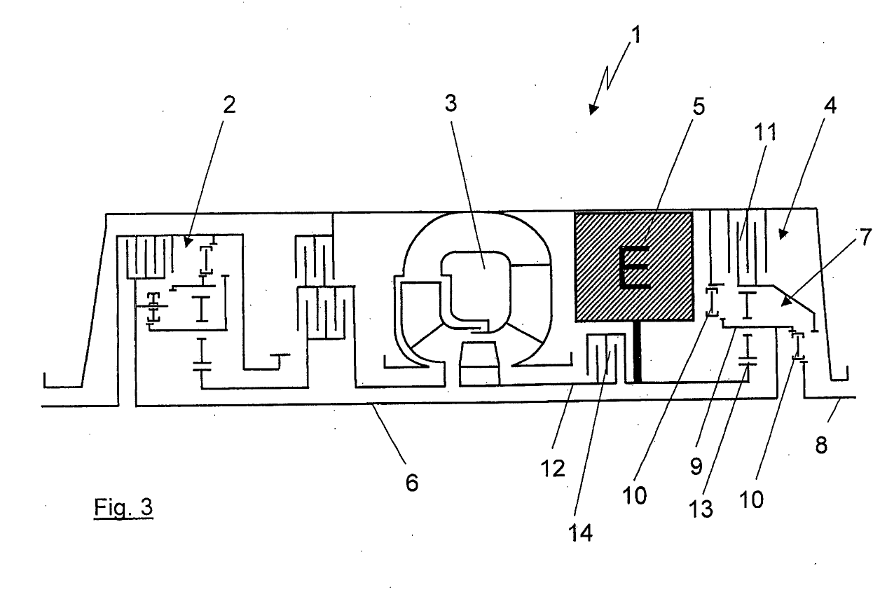

FIG. 3 shows die embodiment of the automatic transmission according to the invention as in FIG. 2 in another configuration;

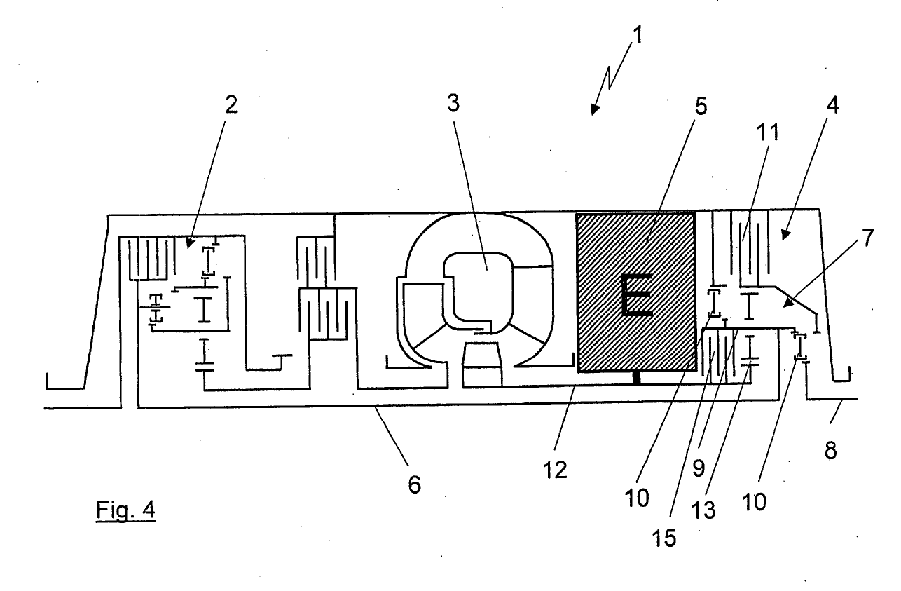

FIG. 4 shows die embodiment of the automatic transmission according to the invention as in FIG. 2 in another alternative configuration;

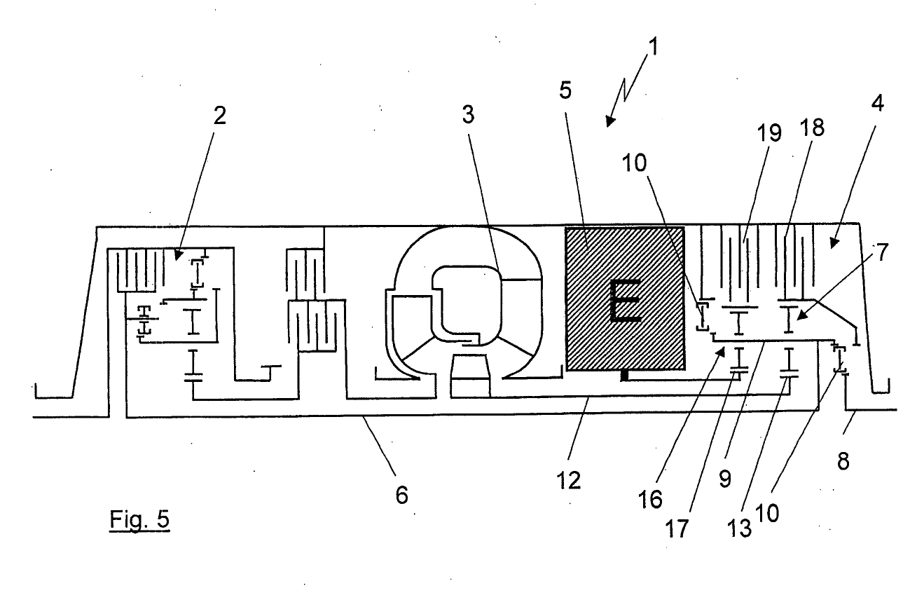

FIG. 5 shows another embodiment of the automatic transmission according to the invention in a first configuration;

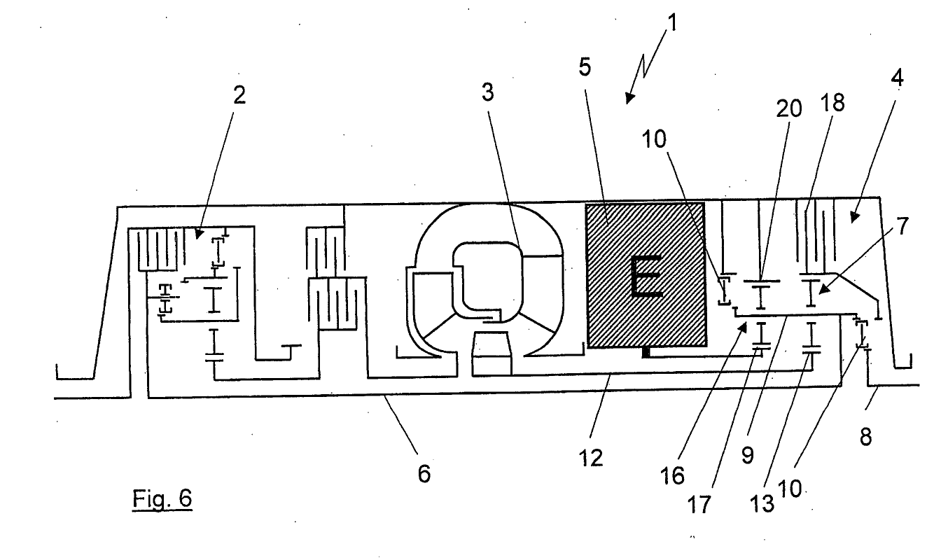

FIG. 6 shows die embodiment according to FIG. 5 in another alternative configuration;

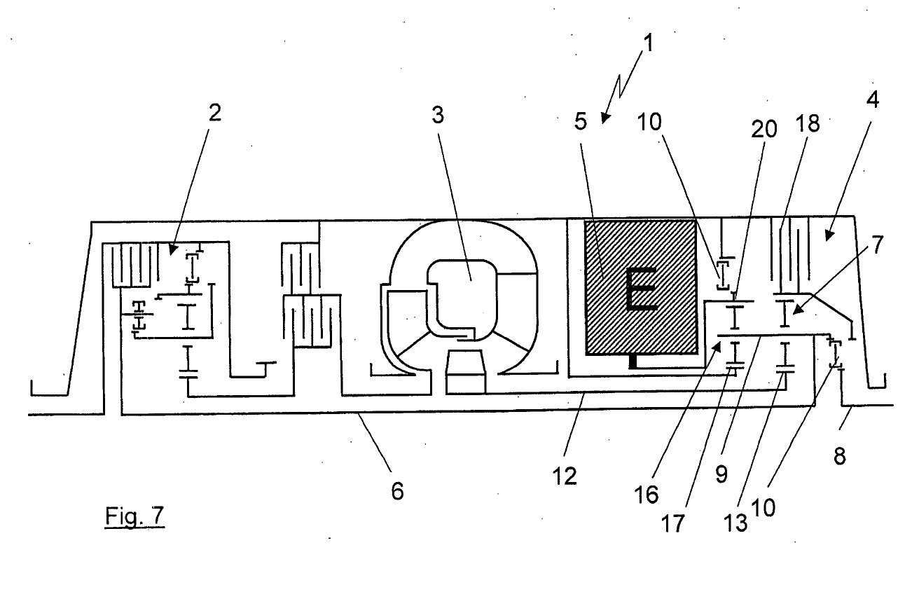

FIG. 7 shows die embodiment according to FIG. 5 in another alternative configuration;

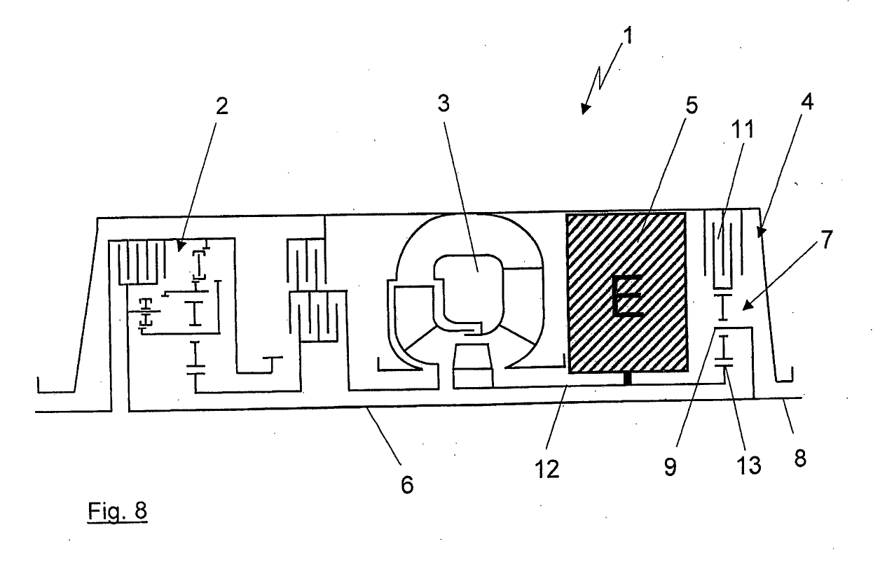

FIG. 8 shows another embodiment of the automatic transmission according to the invention in a first configuration;

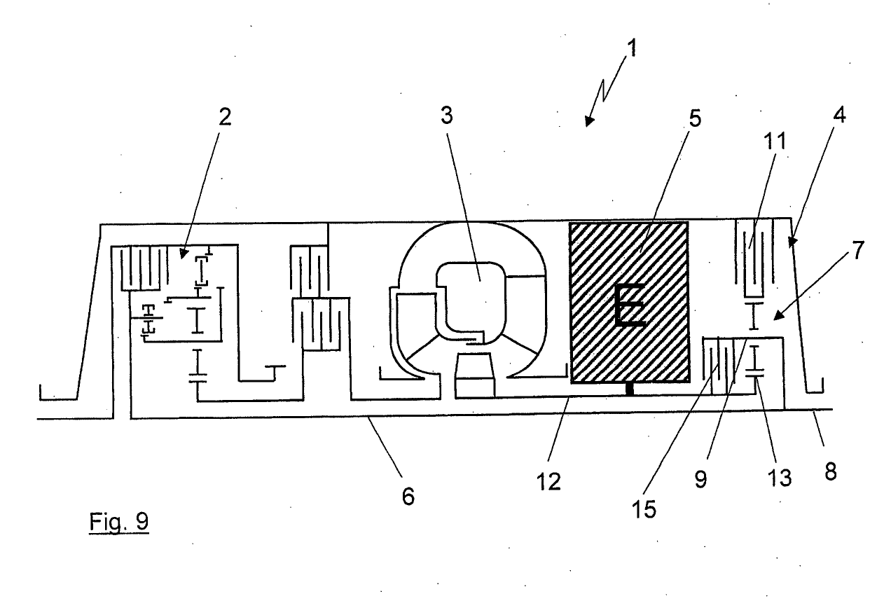

FIG. 9 shows die embodiment according to FIG. 8 in another alternative configuration;

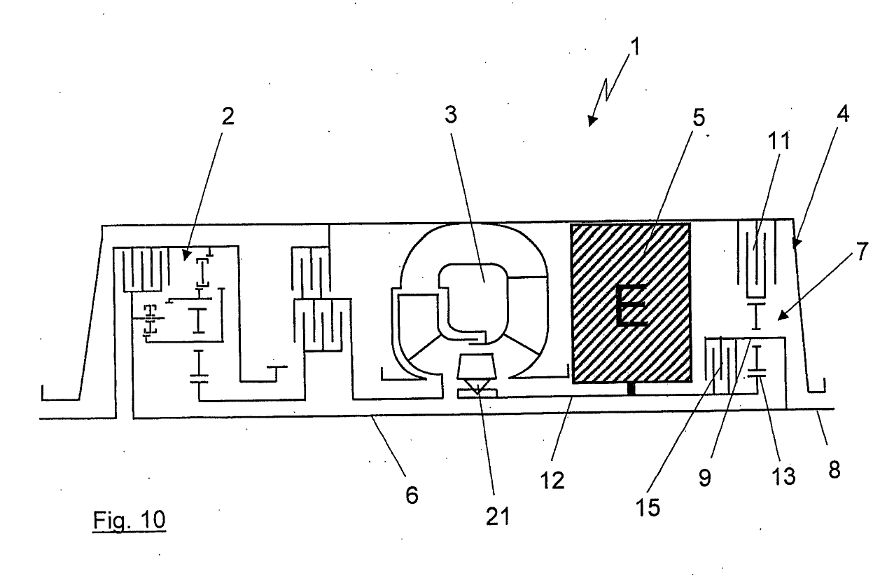

FIG. 10 shows die embodiment of the automatic transmission according to the invention as in FIG. 9 in another configuration; and

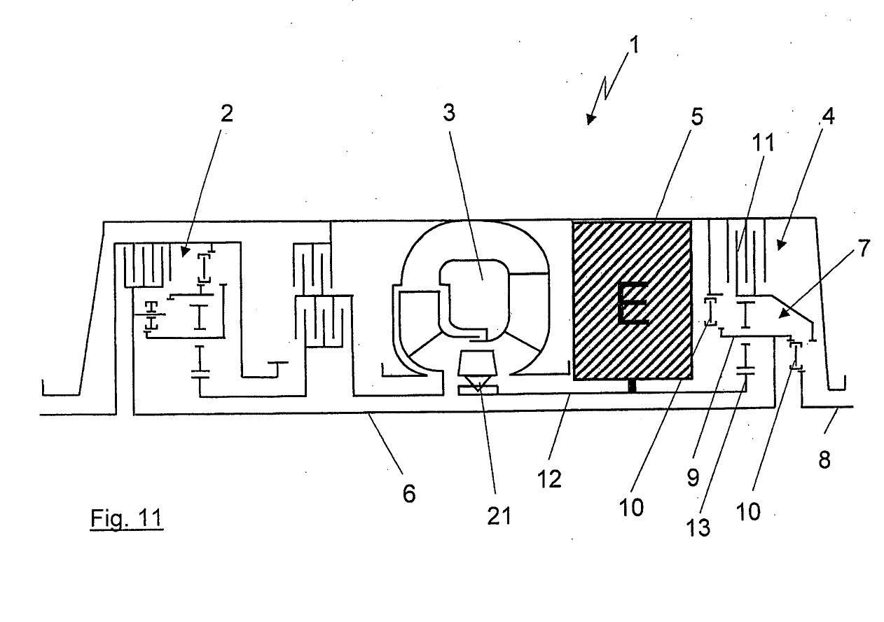

FIG. 11 shows die embodiment of the automatic transmission according to the invention as in FIG. 2 in another configuration.

FIG. 1 shows an automatic transmission 1 fitted with a drive region 2, a hydrodynamic converter 3 and a driven region 4. Additionally, the automatic transmission 1 includes an electrical machine 5. The drive region 2 of the automatic transmission 1 is provided by way of example in the selected representation and corresponds to the structure, which is substantially known from the German patent application DE 10 2008 010 064. This structure of the drive region 2 illustrated on FIG. 1 should here only be understood by way of example, since the fundamental idea of the invention functions with any type of drive region 2, which can split the power into at least two power branches.

The embodiment illustrated here includes both power branches, i.e. a power branch which runs across the hydrodynamic converter 3 and parallel thereto a power branch 6, which runs through hydrodynamic converter 3, parallel to the power branch, with a purely mechanical coupling. Both these power branches are hence reunited in the driven region 4 via an appropriate transmission 7. Here again, the illustration of the driven region 4 and of the automatic transmission 1 should be understood by way of example exclusively, wherein the functionality basically corresponds to that which is described in the German application DE 10 2008 027 946. Alternately, a traditional structure with typically two planetary sets could be envisioned in the driven region.

In addition to the structure of the automatic transmission 1 known so far as regards drive region 2, hydrodynamic converter 3 and driven region 4, the aforementioned electrical machine 5 is present as well. The electrical machine 5 is hence incorporated into the housing of the automatic transmission 1 as well, to achieve a compact structure. The electrical machine 5 acts on a power take-off 8 of the automatic transmission 1 in the embodiment of FIG. 1. To do so, the electrical machine 5 is connected fixedly to the web 9 of the transmission 8 of the driven region 4 which is designed as a planetary gear. The purely mechanical power branch 6 is also connected fixedly with this web 9. Appropriate triggering of claw couplings 10 and/or of the lamella coupling 11 enables to actuate the electrical machine with the transmission ratio 1:1 with said mechanical power branch 6, together or by way of assistance, or if the mechanical power branch 6 is decoupled using an appropriate circuit in the area of the drive region 2, for acting only on the power take-off 8. According to whether traction energy is required on the power take-off 8 or braking energy accrues on the power take-off 8, the electrical machine 1 can hence be used as a motor or a generator which either transforms electric energy into propulsion power or recycles braking energy into electrical energy. Contrary to purely braking via the converter 3 acting as a wear-free retarder, the electrical machine 5 enables to brake down until standstill.

FIG. 2 represents an alternative embodiment of the automatic transmission 1, wherein the elements designated by the same reference signs are identical to or comparable with those described on FIG. 1.

The difference lies here in the coupling of the electrical machine 5 on the driven region 4. In this embodiment, the electrical machine 5 is directly coupled to a turbine shaft 12 of the hydrodynamic converter 3. The electrical machine 5 hence acts together with the hydrodynamic converter 3 on the turbine shaft 12, which is again united with the purely mechanical power branch 6 via the driven region 4. To do so, the planetary gear 7 is again provided in the driven region, which decouples the turbine shaft 12 over the sun wheel 13 and the purely mechanical power branch 6 over the web 9, to supply power on the power take-off 8 with a corresponding constellation or, when braking, to transmit power from the power take-off 8 to the turbine shaft 12, which can be then braked by the electrical machine 5 in a generator operation as well as by the converter 3.

The high transmission ratio between the electrical machine and the power take-off enable to achieve sufficient starting torques even purely electrically. Consequently, the electrical machine can be configured accordingly smaller with respect to the embodiment on, FIG. 1 as regards its torque.

It is then basically possible to deactivate the hydrodynamic converter 3, wherein said converter is not decoupled but operated without working fluid, and then rotates with minimum resistance. Thus, the electrical machine 5 can be operated practically on its own regardless whether working with a drive unit or with a generator. This may prove meaningful for instance for recycling maximum braking energy or when braking down to a standstill. Should the hydrodynamic converter 3 however prove necessary, said converter must only be refilled with the working fluid, which is comparatively time-consuming.

FIG. 3 hence represents a structure which differentiates with respect to that in FIG. 2 exclusively through an additional lamella coupling 14. This lamella coupling 14 enables to interrupt the coupling of the turbine shaft 12 of the hydrodynamic converter 3 with the electrical machine 5. With an open lamella coupling 14, exclusively the electrical machine 5 is hence coupled as shown on FIG. 2, while the hydrodynamic converter 3 is completely decoupled by the open lamella coupling 14. Consequently, the working fluid can be left in the hydrodynamic converter 3, even if said converter is not operated. This enables to minimise the amount of energy, control respectively regulation and time needed as regards the emptying and the filling of the hydrodynamic converter 3.

Moreover, inasmuch as the hydrodynamic converter is kept filled, should said hydrodynamic converter 3 be required for braking, which is typically the case at high revolution speeds, it could then come into play very quickly. This enables to brake quite quickly, since a very quick reaction of the hydrodynamic converter 3 can be achieved by closing the lamella coupling 14, without needing to fill said converter with the working fluid first.

The structure according to FIG. 4 substantially corresponds to that in FIG. 2. Instead of the structure on FIG. 2, a coupling in particular a lamella coupling 15, is provided which is arranged between the web 9 and the sun wheel 13 of the planetary set 7. This structure enables to couple the turbine shaft 12, which is connected to the electrical machine 5 and the hydrodynamic converter 3, with the power take-off 8 using different transmission ratios over the driven region 4. This variability of a second transmission ratio, in particular of a 1:1 transmission ratio, between turbine shaft 12 and power take-off 8 enables, to involve less effort when configuring the electrical machine 5 and the hydrodynamic converter 3, since here the required rotation speed spread can be reduced through the additional transmission ratio, or alternately the achievable rotation speed can be increased. In particular, the electrical machine 5 can so be better optimised in an intrinsically smaller operating range, so that the electrical machine 5 can be optimised as regards its constructive aspects and hence be designed more economically and more energy efficiently. Consequently, an electrical machine with lower maximum rotation speed can be mounted.

The structure illustrated on FIG. 4, which should be understood as a further embodiment of the basic embodiment of FIG. 2, could also be represented additionally with the configuration according to FIG. 3, i.e. an additional lamella coupling 14 in the turbine shaft 12 between the electrical machine 5 and the hydrodynamic converter 3. Such a structure would appear obviously in FIGS. 3 and 4 and hence need not be represented explicitly in a separate embodiment.

FIG. 5 represents another alternative embodiment of the automatic transmission 1. The driven region 4 hence shows an additional planetary set 16, which is connected to the planetary set 7 and to the purely mechanical power branch 6 via a common web 9. Should the structure of the driven region already include more than a single planetary set, for example two planetary sets—as quite common—, it would affect for instance the third planetary set for the additional planetary set 16.

The power branch is again coupled via the hydrodynamic converter 3, via the planetary gear 7 and here in particular via the sun wheel 13 thereof. The electrical machine 5 coupled via the additional planetary gear 16, wherein the electrical machine 5 is also connected to the sun wheel 17 of this planetary gear 16. This structure, whereas the electrical machine 5 and the hydrodynamic converter are always coupled via an own transmission in the driven region 4, enables to design the structure still more variably, since different transmission ratios may be selected for the electrical machine 5 and the power branch via the hydrodynamic converter 3. Both transmissions 7, 16 are hence operated via the lamella couplings 18, 19 in such a way that said couplings can be switched accordingly when actuated respectively not actuated, so that either the electrical machine 5 and the hydrodynamic converter 3 are coupled, or that always only one of the elements or also none of the elements is coupled in the driven region 4.

The structure described in the context of the embodiment according to FIG. 4, for which a direct connection can be achieved between the electrical machine 5 and the power take-off 8 via the lamella coupling 15, can obviously be envisioned in the configuration according to FIG. 5. Here also the lamella coupling 15, which is not represented, could be arranged between the sun wheel 17 of the planetary gear 16 and the common web 9.

The structure on FIG. 6 again shows a comparable configuration as on FIG. 5, whereas here however only a lamella coupling 18 is available, so that solely the hydrodynamic converter 3 can be switched accordingly, while the electrical machine 5 remains coupled fixedly.

In complement thereto additional structures could be envisioned in non-illustrated embodiments. Thus both transmissions 7,16 could be coupled fixedly without lamella coupling, or alternately thereto only the additional transmission 16 would present a lamella coupling 19, however not the transmission 7 for the power branch via the hydrodynamic converter 3. Analogically to the embodiments in FIG. 5, the direct connection of the common web 9 with the sun wheel 17 of the planetary gear 16 could also be envisioned in the embodiment of FIG. 6 via the lamella coupling 15 not illustrated here, so that a direct 1:1-coupling of the electrical machine 5 to the power take-off 8 is possible.

FIG. 7 now shows a structure analogically to that of FIG. 6. The sole difference here lies in that the coupling of the electrical machine does not involve the sun wheel 17 of the planetary gear 16, but a hollow wheel 20 thereof. If the hollow wheel 20 were connected fixedly with the housing of the automatic transmission 1 on FIG. 6, the sun wheel 17 is now connected fixedly with the housing of the automatic transmission 1. The electrical machine 5 is coupled via hollow wheel 20. The other structure corresponds that of the previous figure.

As a matter of principle, the embodiment illustrated on FIG. 7 must show that in all described arrangements and illustrated structures with planetary gears, the represented constellation should always be understood by way of example. As usual with planetary gears, it can always be basically envisioned to couple and/or to decouple corresponding forces via sun wheel, hollow wheel, web. These coupling schemes, as understandable to the man of the art, can be replaced for one another, without modifying the basic structure of the examples of embodiment illustrated here, since the thought behind the invention could also be realised with every other thinkable coupling of the planetary sets illustrated here. A direct connection of the power take-off 8 with of the electrical machine 5 could also be envisioned in the illustration of the automatic transmission 1 according to FIG. 7. Here also the corresponding coupling should involve the coupling 15, not represented. Otherwise than with both previous figures, the sun wheel 17 however need not be connected to the common web 5, but the hollow wheel 20 of the planetary gear 16.

FIG. 8 represents a fourth alternative embodiment of the automatic transmission 1, whereas here also the elements designated by the same reference signs are identical to or comparable with those derived from the previous figures. The below with respect for instance to the embodiment of FIG. 2 now lies in that only the planetary gear 7 is available to the driven region 4 as single planetary gear. Otherwise than in the embodiment according to FIG. 2, means for modifying the coupling structure of this planetary gear 7, for instance the claw couplings 10 illustrated in the previous figure, have been dispensed with.

The structure then becomes particularly straightforward and can be realised with a few elements quite cost efficiently and in an extraordinarily compact manner as regards the construction space requirements. Moreover any formerly required actuation of the claw couplings, complete with all necessary circuits, actuators, control software and similar can be dispensed with.

Due to the missing possibility of modifying the coupling structure of the planetary gear 7 in the driven region 4, using the driven region 4 for mechanically/mechanically-hydrodynamically driving in reverse gear after appropriate modification of the coupling structure is not possible any longer. Thanks to the electrical machine 5 this is however not problematic, since the electrical machine 5, whose rotation direction can be reversed at will by a simple modification of the actuation system, enables driving in reverse gear via the driven region 4 and the electrical machine 5 acting as an engine, also without the need to modify its coupling structure. The quite straightforward compact structure of the automatic transmission 1 according to FIG. 8 can thus be realised without restricting its functionality.

Another alternative configuration of the embodiment of the automatic transmission according to FIG. 8 can now be seen in the representation of FIG. 9. Here also the reference signs already known from the previous figures are used for comparable or identical components. The difference of the representation of FIG. 9 with respect to the embodiment shown on FIG. 8 now lies in the additional lamella coupling 15, via which the sun wheel 13 and the web 9 of the planetary gear 7 can be connected. The principle of this lamella coupling 15 is already known from the structure illustrated on FIG. 4. In the configuration according to FIG. 9, it also fulfils a comparable task, so that here also two different transmission ratios can be achieved when coupling the turbine shaft 12 with the power take-off 8. In particular with a closed lamella coupling 15, a 1:1 transmission ratio can be realised so as to limit that the maximum rotation speed of the electrical machine 5.

The same structure as in the representation of FIG. 9 can be seen substantially in the representation of FIG. 10. The difference between the various illustrations lies in an additional element namely a free-wheel 21 between the turbine of the hydrodynamic converter 3 and the turbine shaft 12. The free-wheel 21 avoids introducing a force and hence creating a drag torque through the turbine in the (partially) filled hydrodynamic converter 3. The free-wheel 21 also enables avoiding drag losses through the turbine into the purely mechanical gears, since the hydrodynamic converter 3 can transmit a corresponding force in one direction only, and no force respectively no power is injected into the hydrodynamic converter 3 in the other direction over the turbine shaft 12 and the free-wheel 21. Consequently, emptying the hydrodynamic converter 3 can also be dispensed with into the driving situations wherein it is not required.

The free-wheel 21 is represented in the illustration of FIG. 10 by way of example for the embodiment of the automatic transmission 1 according to FIG. 9. Resorting to such a free-wheel 21 into the embodiment variations according to FIGS. 2, 4 and 8 could also be envisioned analogically. A structure analogical to FIG. 2 is shown in the representation of FIG. 11, whereas the already described advantages are achieved through the hydrodynamic converter 3 used with the free-wheel 21 between the turbine and the turbine shaft 12. This structure can hence be also used for the configuration according to FIGS. 4 and 8. As a matter of principle, it could also be envisioned with the structure according to FIG. 3. The coupling 14 arranged in the turbine shaft may here however dispense with any free-wheel 21 in principle.

1-11. (canceled)

12. An automatic transmission with hydrodynamic converter, which includes a drive region, wherein the power can be split in at least two power branches, wherein a power branch runs across the hydrodynamic converter, and which includes a driven region, wherein said at least two power branches can be united, characterized in that additionally one electrical machine is coupled with the driven region.

13. The automatic transmission according to claim 12, characterized in that the electrical machine is coupled directly to at least one power branch without the hydrodynamic converter.

14. The automatic transmission according to claim 12, characterized in that the electrical machine is coupled to said at least one power branch with the hydrodynamic converter.

15. The automatic transmission according to claim 12, characterized in that the electrical machine is coupled via at least one transmission element.

16. The automatic transmission according to claim 13, characterized in that the electrical machine is coupled via at least one transmission element.

17. The automatic transmission according to claim 14, characterized in that the electrical machine is coupled via at least one transmission element.

18. The automatic transmission according to claim 12, characterized in that the electrical machine can be decoupled from the driven region using a coupling element.

19. The automatic transmission according to claim 13, characterized in that the electrical machine can be decoupled from the driven region using a coupling element.

20. The automatic transmission according to claim 14, characterized in that the electrical machine can be decoupled from the driven region using a coupling element.

21. The automatic transmission according to claim 15, characterized in that the electrical machine can be decoupled from the driven region using a coupling element.

22. The automatic transmission according to claim 16, characterized in that the electrical machine can be decoupled from the driven region using a coupling element.

23. The automatic transmission according to claim 17, characterized in that the electrical machine can be decoupled from the driven region using a coupling element.

24. The automatic transmission according to claim 14, characterized in that the connection between electrical machine and hydrodynamic converter includes a coupling element.

25. The automatic transmission according to claim 14, characterized in that the connection between electrical machine and hydrodynamic converter includes a free-wheel.

26. The automatic transmission according to claim 15, characterized in that the driven region is designed in such a way that at least two selectable transmission ratios are available between the power take-off of the hydrodynamic converter which can be coupled with the electrical machine and the power take-off of the automatic transmission.

27. The automatic transmission according to claim 14, characterized in that the driven region presents exactly one planetary gear with a fixed coupling structure.

28. The automatic transmission according to claim 12, characterized in that the electrical machine can be coupled directly to the power take-off of the driven region via a coupling.

29. The automatic transmission according to claim 13, characterized in that the electrical machine can be coupled directly to the power take-off of the driven region via a coupling.

30. The automatic transmission according to claim 12, characterized in that the electrical machine is integrated in a housing of the automatic transmission.

31. The automatic transmission according to claim 13, characterized in that the electrical machine is integrated in a housing of the automatic transmission.
